(19) United States
(12) Patent Application Publication
(10) Pub. No.: US 2017/0330099 A1
(43) Pub. Date: Nov. 16, 2017

(54) SYSTEMS AND METHODS FOR AUTOMATED DATA INPUT ERROR DETECTION

(71) Applicant: Misys International Banking Systems Limited, London (GB)

(72) Inventor: Eleonore de Vial, London (GB)

(21) Appl. No.: 15/283,142

(22) Filed: Sep. 30, 2016

Related U.S. Application Data
(60) Provisional application No. 62/334,939, filed on May 11, 2016.

(51) Int. Cl. G06N 7/00; G06F 11/07; G06N 99/00

(52) U.S. Cl. CPC G06N 7/005; G06N 99/005; G06F 11/0721; G06F 11/079

(57) ABSTRACT

Various embodiments of the present disclosure can include systems, methods, and non-transitory computer readable media configured to receive historical transaction information associated with one or more historical transactions. A machine learning model is trained based on the historical transaction information. Transaction information associated with a transaction to be analyzed for potential data input errors is received. A potential data input error is detected in the transaction information based on the machine learning model. A visual indication is provided on a graphical user interface based on the detecting the potential data input error.

### CROSS-REFERENCE TO RELATED APPLICATIONS

The present application claims priority to U.S. Provisional Application No. 62/334,939, filed on May 11, 2016, the entire contents of which are incorporated by reference as if fully set forth herein.

### FIELD OF THE INVENTION

The present technology relates to financial software platforms. More particularly, the present technology relates to automated detection of data input errors.

### BACKGROUND

Financial software platforms are commonly used to carry out various types of financial transactions. For example, financial software platforms can be used to conduct trading of various assets and/or securities. Many financial software platforms require users to input information into the platform. A financial software platform may rely on user-inputted information to take particulars actions. For example, users may be required to input data specifying one or more financial transactions. A financial transaction can identify, inter alia, an action (e.g., buy or sell), a quantity, and an asset (e.g., a security in a particular good or entity).

Errors by users inputting data, i.e., data input errors, can create costs for customers and vendors utilizing or offering a financial software platform. For example, there can be costs caused directly by the error, e.g., if a user erroneously inputs a command to purchase 100 shares instead of 10 shares. Costs can also be incurred in an effort to detect, prevent, and/or correct data input errors. For example, many financial services companies have employees tasked with reviewing transactions to find and correct errors. These employees must be paid for their time spent looking for and correcting data input errors. Data input errors may also result in further, non-quantifiable costs, such as decreasing customer confidence and lost business, as customers may choose to use other vendors or platforms if a particular vendor or platform has a reputation for a high frequency of data input errors.

### SUMMARY

Various embodiments of the present disclosure can include systems, methods, and non-transitory computer readable media configured to receive historical transaction information associated with one or more historical transactions. A machine learning model is trained based on the historical transaction information. Transaction information associated with a transaction to be analyzed for potential data input errors is received. A potential data input error is detected in the transaction information based on the machine learning model. A visual indication is provided on a graphical user interface based on the detecting the potential data input error.

In an embodiment, the detecting the potential data input error comprises determining a likelihood of error for a data field based on the machine learning model and determining that the likelihood of error exceeds a threshold likelihood value.

In an embodiment, the historical transaction information comprises initial transaction information and audited transaction information associated with the initial transaction information.

In an embodiment, the training the machine learning model based on the historical transaction information comprises: determining historical errors based on differences between the initial transaction information and the audited transaction information.

In an embodiment, the training the machine learning model based on the historical transaction information further comprises: receiving a second set of initial transaction information and a second set of audited transaction information associated with the second set of initial transaction information; testing the machine learning model based on the second set of initial transaction information and the second set of audited transaction information; and re-training the machine learning model based on the testing the machine learning model.

In an embodiment, the training the machine learning model comprises selecting a first machine learning algorithm, and the re-training the machine learning model comprises selecting a second machine learning algorithm that is different from the first machine learning algorithm.

In an embodiment, the visual indication on the graphical user interface comprises highlighting the potential data input error.

In an embodiment, the shade of the highlighting varies based on a likelihood of error determination made by the machine learning model.

In an embodiment, the transaction information comprises a blank data field, and the method further comprises calculating a default value for the blank data field based on the machine learning model.

In an embodiment, the default value comprises a value satisfying a threshold likelihood of error as determined by the machine learning model.

Many other features and embodiments of the invention will be apparent from the accompanying drawings and from the following detailed description.

### BRIEF DESCRIPTION OF THE DRAWINGS

FIG. 1 illustrates an example system including an automated data input error detection module, according to an embodiment of the present disclosure.

FIG. 2 illustrates a method associated with training a machine learning model, according to an embodiment of the present disclosure.

FIG. 3 illustrates an example model application module, according to an embodiment of the present disclosure.

FIG. 4 illustrates an example scenario including an example user interface for automated data input error detection, according to an embodiment of the present disclosure.

FIG. 5 illustrates an example scenario including an example user interface for automated data field default value determination, according to an embodiment of the present disclosure.

FIG. 6A illustrates an example flow chart associated with applying a machine learning model, according to an embodiment of the present disclosure.

FIG. 6B illustrates an example system, according to an embodiment of the present disclosure.

FIG. 7A illustrates an example method associated with training and testing an automated data input error machine learning model, according to an embodiment of the present disclosure.

FIG. 7B illustrates an example method associated with applying an automated data input error machine learning model, according to an embodiment of the present disclosure.

FIG. 8 is a diagrammatic representation of an embodiment of the machine, within which a set of instructions for causing the machine to perform one or more of the embodiments described herein can be executed, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Automated Data Input Error Detection

Financial software platforms are commonly used to carry out various types of financial transactions. For example, financial software platforms can be used to conduct trading of various assets and/or securities. Many financial software platforms require users to input information into the platform. A financial software platform may rely on user-inputted information to take particulars actions. For example, users may be required to input data specifying one or more financial transactions. A financial transaction can include various transaction information, such as, inter alia, an action (e.g., buy or sell), a quantity, and an asset (e.g., a security in a particular good or entity).

Errors by users inputting data, i.e., data input errors, can create costs for customers and vendors utilizing or offering a financial software platform. For example, there can be costs caused directly by the error, e.g., if a user erroneously inputs a command to purchase 100 shares instead of 10 shares. Furthermore, costs can be incurred in an effort to detect, prevent, and/or correct data input errors. For example, many financial services companies have employees tasked with reviewing transactions to find and correct errors. These employees must be paid for their time spent looking for and correcting data input errors. There can also be downstream costs, as various decisions are made based on erroneous data or erroneous transactions. Data input errors may also result in further, non-quantifiable costs, such as decreasing customer confidence and lost business, as clients or potential clients may choose to use other vendors or platforms if a particular vendor or platform has a poor reputation.

Certain software platforms attempt to address data input errors by hiring large numbers of employees to conduct manual review of transactions to detect and correct errors. However, as discussed above, such solutions are very expensive and not always reliable. Certain software platforms also try to address some of the problems discussed above by implementing hard-coded business rules designed to notify users of potential data input errors. However, such hard-coded business rules face various disadvantages. For example, such hard-coded business rules are, by definition, not dynamic, and do not adapt to an individual user's profile and habits. Furthermore, such hard-coded rules face the issue of defining either too few or too many controls. If there are too few controls included, then certain errors may not be detected. However, if too many controls are included, then users may become desensitized to error warnings and prone to ignore such warnings. Hard-coded business rules are also unable to manage situations that are particularly complex and too difficult to address in a pre-defined, hard-coded rule.

An improved approach rooted in computer technology overcomes the foregoing and other disadvantages associated with conventional approaches specifically arising in the realm of computer technology. Based on computer technology, the disclosed technology provides techniques for training and applying a machine learning model to automatically detect potential data input errors. In certain embodiments, a set of transactions can be selected and provided to train the machine learning model. Each transaction of the set of transactions can include an initial version, including one or more initial input fields, and an audited version, including one or more audited input fields. Each of the audited input fields corresponds to a respective one of the initial input fields. In certain embodiments, a human reviewer can review the initial version of a transaction, and create an audited version of the transaction by either confirming the initial version of the transaction, or making any necessary changes or revisions. If an audited input field differs from its corresponding initial input field, then it can be determined that an error occurred and was corrected. By undergoing such levels of review and being trained by many different transactions, the machine learning model can be trained to determine the likelihood that a given data field for a transaction is erroneous. Once a model has been trained, it can be applied to new transactions so as to detect potential data input errors as a user is entering data for a transaction and/or before the transaction is exported for processing and execution.

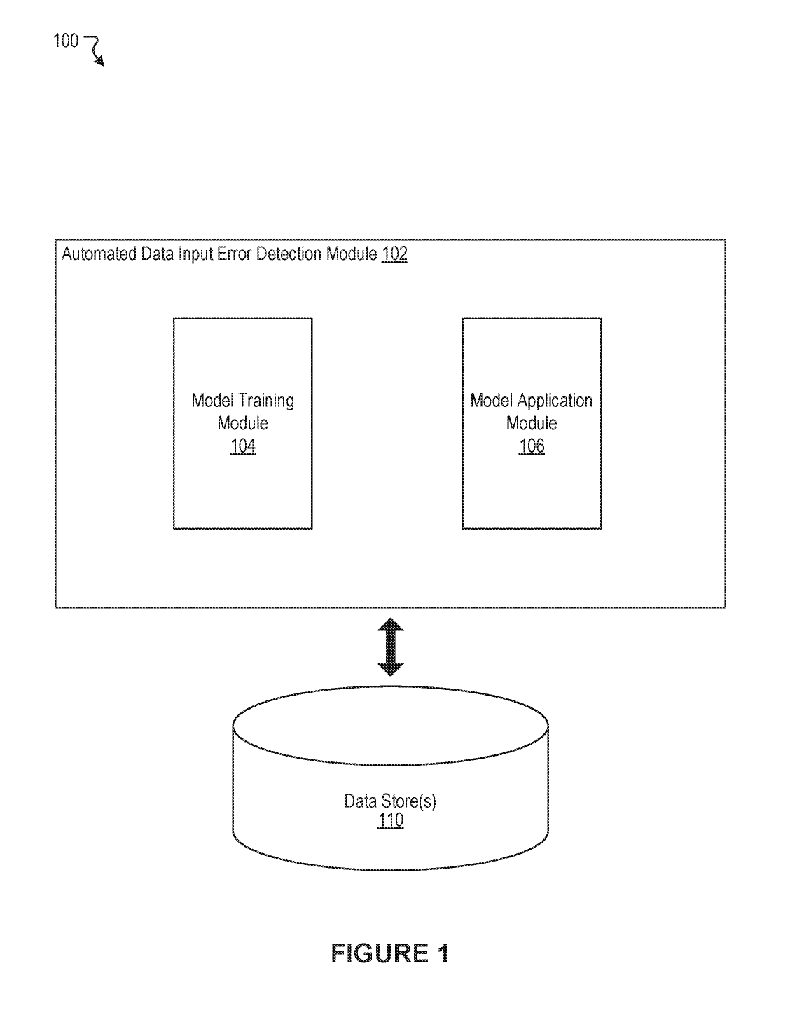

FIG. 1 illustrates an example system 100 including an automated data input error detection module 102, in accordance with an embodiment of the present disclosure. The automated data input error detection module 102 can be configured to train a machine learning model to detect potential data input errors. The automated data input error detection module 102 can also be configured to apply the machine learning model to detect potential data input errors, and provide an indication to a user of the potential data input error. In certain embodiments, data input errors are detected by determining a likelihood that a data input is erroneous and determining if the likelihood exceeds a threshold value. If the likelihood of an error does exceed the threshold likelihood value, then an indication can be provided that a potential error has been detected. For example, a potentially erroneous field can be highlighted in a particular color indicative of a potential data input error. In certain embodiments, the automated data input error detection module 102 can also be configured to automatically determine a default value for one or more data fields based on a machine learning model. These embodiments will be discussed in greater detail herein.

As shown in FIG. 1, the automated data input error detection module 102 can be configured to communicate with a data store 110. The data store 110 can be configured to store and maintain various types of data to facilitate the training and application of the model training module, as discussed in more detail herein. It should be noted that the components shown in this figure and all figures herein are exemplary only, and other implementations may include additional, fewer, integrated or different components. Some components may not be shown so as not to obscure relevant details.

As shown in FIG. 1, the automated data input error detection module 102 can include a model training module 104 and a model application module 106. The model training module 104 can be configured to train a machine learning model to determine potential data input errors. In certain embodiments, the machine learning model can determine potential data input errors by calculating a likelihood that a particular data input is erroneous. If the likelihood of error surpasses a threshold value, then the data input is flagged as a potential data input error. The model training module 104 can be configured to receive a set of training data including a plurality of transactions to train the machine learning model. Each transaction of the training data can be defined by a set of data fields. For example, a simple transaction can include an action data field (e.g., buy or sell), a quantity data field (e.g., defining a number of shares or a dollar value), and an asset data field (e.g., an asset that is to be bought or sold or traded). Furthermore, each transaction of the training data can be defined by an initial version defining a set of initial data fields as they were originally entered, and an audited version defining a set of audited data fields that have been audited. For example, an initial version of a transaction may be entered by a first data input user to initiate a transaction. However, before the transaction is exported for processing and/or execution, the transaction can be audited by an auditor, who reviews the data inputted by the first data input user to ensure that data was entered correctly. If everything appears to be correct, then the transaction can be exported for execution. If any data fields appear to have been inputted incorrectly, the auditor can correct the data field or send the transaction back to the first data input user for correction. In certain embodiments, each audited data field in an audited version of a transaction can correspond to a respective one of an initial data field of the initial version of the transaction. The machine learning model can be provided with an initial version of a transaction and an audited version of a transaction, and can detect any errors in the initial version by determining whether any changes have occurred between the initial version and the audited version. By reviewing many different transactions, the machine learning model can be trained to determine the likelihood that a particular data input is erroneous.

In certain embodiments, a subset of transactions can be selected for training the machine learning model, and a subset of transactions can be selected for testing the machine learning model. For example, 20% of transactions in a given time period (e.g., from a particular day) can be selected to train the machine learning model. In certain embodiments, the machine learning model comprises a plurality of decision trees input with bootstrap samples of the training set, and the plurality of decision trees are aggregated into a single decision function. A separate set of transactions can be selected as a test set to test the machine learning model after it has been trained. The test set includes transactions that have already been audited by a group of human auditors. As such, any errors contained in the test set of transactions are already known. The accuracy of the machine learning model can be determined by providing the machine learning model with the initial versions of transactions contained in the test set and comparing the data input errors detected by the machine learning model to those found by the human auditors. The machine learning model can be revised and or further trained based on the results of such testing. For example, if a first machine learning algorithm is used to train the machine learning model (e.g., a Random Forest algorithm, a CART algorithm, a SVM-C algorithm, etc.), but the test reveals that the machine learning algorithm is not particularly effective, a different machine learning algorithm can be selected to re-train the machine learning algorithm. In another example, if it is determined that the machine learning algorithm is not effectively detecting errors in a particular data field, the data field can be specified during additional training so that during training the machine learning algorithm pays particular attention to errors in that data field as it is further trained.

The training of the machine learning model can continue to be updated based on new transactions. For example, a subset of transactions (e.g., 20% of all transactions made during the day) can be periodically selected for updating the training of the machine learning model. In certain embodiments, more recent transactions can be given greater weight than older transactions.

In certain embodiments, the machine learning model can be trained so as to calculate error probabilities or likelihoods on a per-user basis. It may be the case that particular users tend to make similar mistakes repeatedly. As such, it may be beneficial for the machine learning model to make likelihood of error determinations based on an identification of the user that entered the transaction data. Transaction information provided to the machine learning model, both in the training phase and in the application phase (discussed in greater detail below), can include a data entry user identification field.

In certain embodiments, the model training module 104 can also be configured to train a model to automatically determine default values for one or more data fields in a transaction. A single model can be trained to both detect potential data input errors and to determine default values, or separate models can be trained and used. In certain embodiments, the machine learning model can determine a default value for a data field based on one or more data fields input by a user. Using the data fields entered by the user, the model can be trained to identify one or more similar transactions that have previously been entered, and to determine a default value for the data field based on the one or more similar transactions. In certain embodiments, the model, in determining default values, can also determine a likelihood of error for any default values determined (or, alternatively, to determine a certainty value indicative of the likelihood that the default value is an acceptable value). The likelihood of error can be presented to the user along with the default value so that the user can be notified of any default values that may require a second look. For example, a default value can be highlighted with varying shades of one or more colors indicative of greater or lesser likelihood of error (or certainty). Alternatively, certain default values that fail to satisfy an error or certainty threshold can be highlighted, e.g., any default values that have a high likelihood of error or a low certainty value can be highlighted so that a user knows that that value should be reviewed.

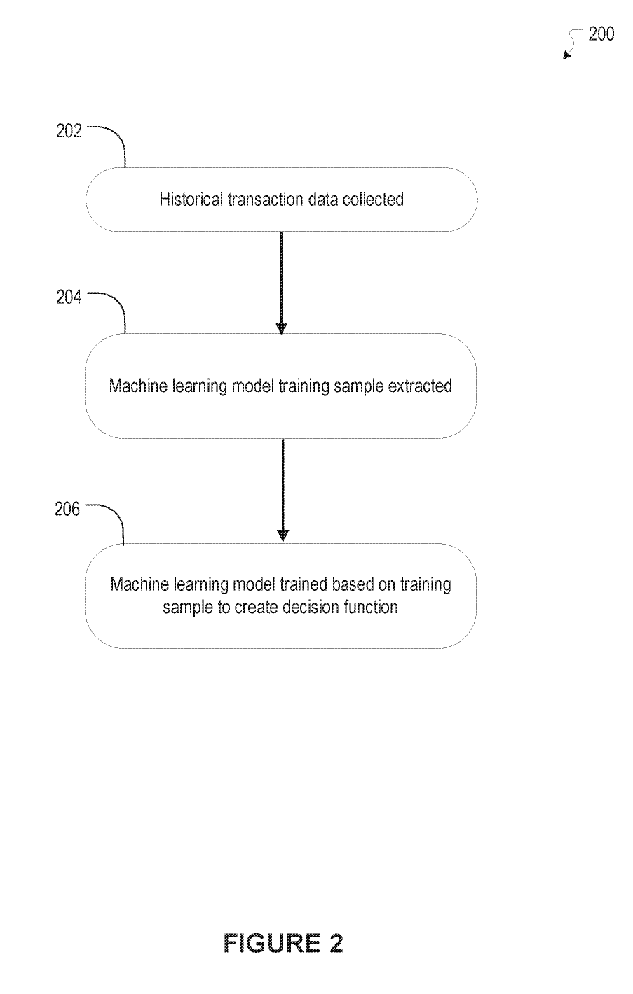

FIG. 2 illustrates a flowchart of an example method 200 associated with training a machine learning model. At block 202, the example method 200 can collect historical data. At block 204, the example method 204 can extract a machine learning model training sample. At block 206, the example method 206 can train a machine learning model based on the training sample to create a decision function.

Returning to FIG. 1, the model application module 106 can be configured to apply a machine learning model to detect potential data input errors. Once a machine learning model has been trained, it can be implemented on a financial software platform to detect potential data input errors before transactions are executed. In this way, data input errors can be detected and corrected before any damaging or even potentially catastrophic consequences are incurred. For example, the model application module 106 can be configured to provide an indication to a user of potential input errors as the user is entering data into a financial software platform. If the user enters a value into a particular data field that the machine learning model determines is potentially erroneous, the user can be provided with a visual indication of such determination. This can occur real-time, i.e., as a user is entering data, or it can occur upon user request, e.g., by the user clicking a “check entries” button, or it can occur automatically upon user submission of a transaction for execution. In other embodiments, an indication of potential input errors can be provided for one or more transactions that have already been inputted, e.g., during a review process. For example, when a front office data entry user enters transaction information for a transaction, the transaction information can be transmitted to a back office review user for review before the transaction is exported and/or executed. The back office review user can be provided with an interface listing one or more transactions, and can be notified of any transactions with potential errors detected. In this way, the back office review user can be notified of transactions that require particular scrutiny based automated error detection by the machine learning model.

In certain embodiments, the model application module 106 can also be configured to determine default values for one or more data fields. As discussed above, as a user is entering transaction information for a transaction, including a plurality of data fields, the user can enter a subset of the plurality of data fields, and request that the machine learning model automatically fill in any remaining data fields. The machine learning model can be configured to take the subset of the plurality of data fields entered by the user and to determine one or more similar transactions previously entered. Based on the one or more similar transactions identified, the machine learning model can automatically fill in the remaining data fields.

In certain embodiments, the model application module 106 can also be configured to output statistics reports. For example, at the end of each day, a report can be generated listing all errors that were detected and corrected during that day, or an individual report for an individual data entry user can be provided to the individual data entry user outlining any errors made by that individual data entry user. These reports can be used to avoid future errors. For example, if a user is determined to be making a particular mistake with some frequency, the user can be notified of that issue so as to avoid making that same mistake in the future, or the user can be provided with additional training. The model application module 106 is discussed in greater detail herein

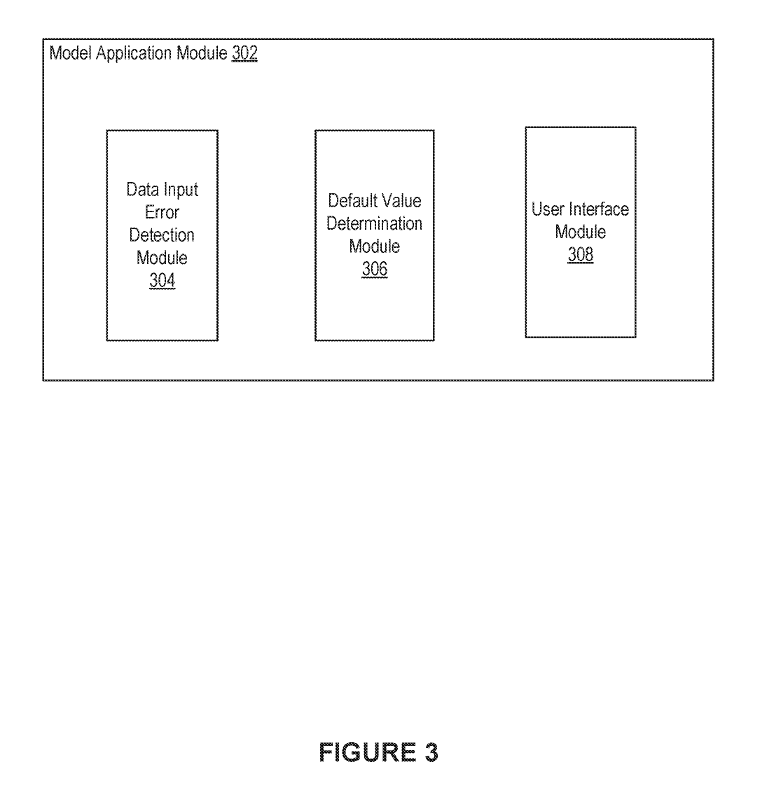

FIG. 3 illustrates an example model application module 302, according to an embodiment of the present disclosure. In certain embodiments, the model application module 106 of FIG. 1 can be implemented as the example model application module 302. As shown in FIG. 3, the example model application module 302 can include a data input error detection module 304, a default value determination module 306, and a user interface module 308.

The data input error detection module 304 can be configured to detect the likelihood of error for one or more data fields in one or more transactions based on a machine learning model. For example, the data input error detection module 304 can be configured to receive a transaction defined by one or more data fields. A machine learning model, such as one trained by the model training module 104, can be configured to receive the transaction. For each data field in the transaction, a likelihood of error can be determined based on the machine learning model. In certain embodiments, if the likelihood of error for any given data field exceeds a threshold, an indication can be provided to a user of a potential data input error. For example, one or more transactions can be listed in a user interface. Each transaction that contains a data field having a likelihood of error above a particular threshold can be highlighted to alert the user to a potential error in the transaction. In another example, rather than highlighting the entire transaction (or in addition to highlighting the transaction), individual data fields exceeding an error threshold can be highlighted, or a widget may be presented indicating one or more potential data input errors. Thresholds for potential data input errors can differ for different data fields. For example, a 50% likelihood of error for one data field may result in an indication of a potential data input error, whereas a 70% likelihood of error is required for a different data field to be indicated as potentially erroneous. These various error thresholds can be automatically determined by the machine learning model, or can be set by a user and implemented in the machine learning model. In certain embodiments, indications of potential data input errors may differ based on the degree of likelihood. For example, if a data field is highlighted in red to indicate a potential data input error, the shade of red used to highlight the data field may become darker to indicate a higher likelihood of error.

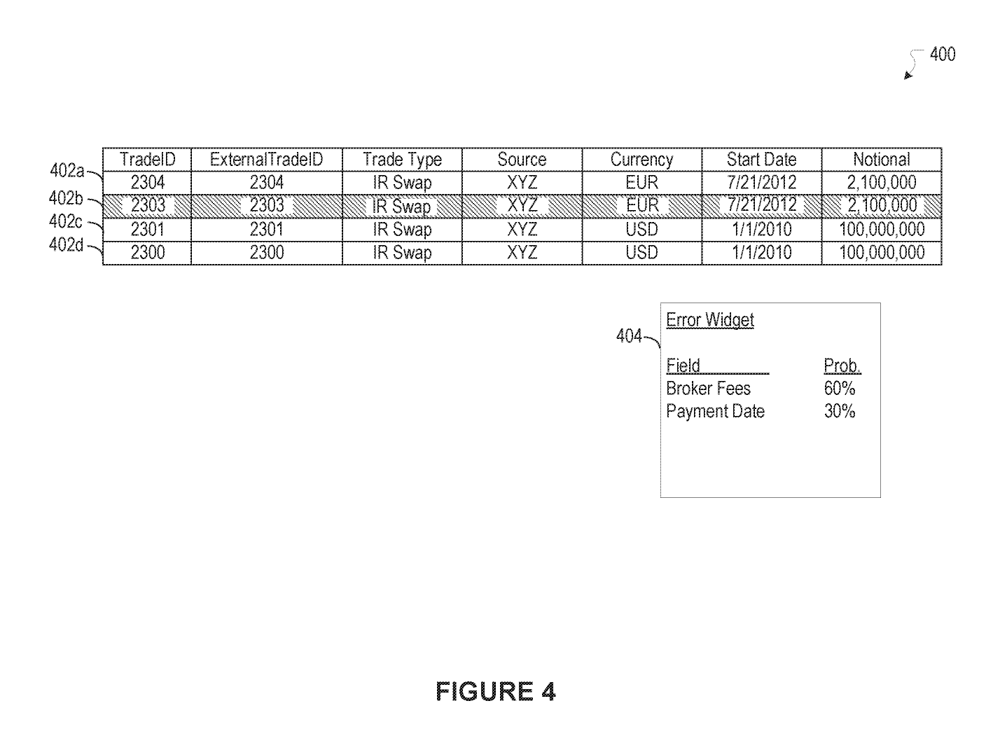

FIG. 4 illustrates an example scenario 400, including a user interface for providing indications of potential data input errors. In the example scenario 400, a user is presented, via a graphical user interface, with a plurality of transactions 402a-d for review. It can be seen in the figure that a transaction 402b is highlighted, whereas the other transactions 402a, 402c, 402d are not, indicating that a potential data input error was detected for transaction 402b. An error widget 404 allows the user to see details about the potential data input errors detected. For example, if the user clicks on transaction 402b, the error widget 404 can show various fields of the transaction information that were detected to be potentially erroneous. In the example scenario 400, the error widget 404 indicates that a “broker fees” field (not shown in FIG. 4) has a 60% probability of being erroneous, and a “payment date” field (not shown in FIG. 4) has a 30% probability of being erroneous. Using this information, the user can review transaction 402b more carefully, and ensure that the transaction information for the transaction was entered correctly, or correct any erroneous transaction information.

In addition to detecting potential data input errors, a machine learning model can be also be trained and utilized to determine default values for various data fields based on historical transaction data. Returning to FIG. 3, the default value determination module 306 can be configured to determine a default value for a data field based on a machine learning model. For example, a transaction can be defined by transaction information comprising a plurality of data fields. A user could enter transaction information for a subset of the plurality of data fields, but leaves other data fields empty. The default value determination module 306 can be configured to automatically fill in the empty data fields based on a machine learning model. This may be useful, for example, where transactions are imported from electronic front office platforms, such as Microsoft Excel. However, these systems may not include all of the back office information required to complete each transaction. A machine learning model can be utilized to provide default values for the missing fields to complete each transaction. In this way, a user can fill in fewer data fields, and there are fewer opportunities to make mistakes. It should be understood that a single machine learning model or multiple machine learning models can be trained and applied to carry out the various functions herein. For example, a single machine learning model can be configured to both determine potential data input errors and automatically fill in default values. Alternatively, separate models can be trained, e.g., one machine learning model to determine potential data input errors, and a separate machine learning model to automatically fill in transaction information.

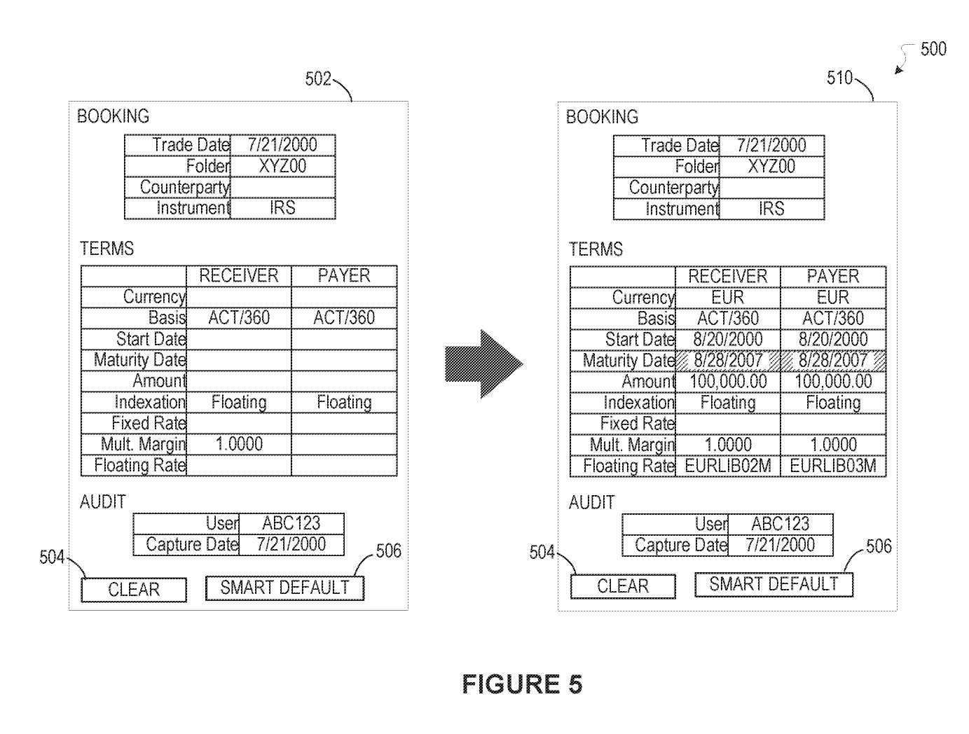

FIG. 5 illustrates an example scenario 500 associated with automated data input based on a machine learning model, in accordance with an embodiment of the present disclosure. In the example scenario 500, a user is presented with a data input interface 502 for the user to enter transaction information for a transaction. It can be seen that, in the data input interface 502, the user has entered some of the transaction information (e.g., Instrument, Receiver/Payer Basis and Indexation, and Mult. Margin). The user is provided with a “clear” button 504 to clear all data fields, and a “smart default” button 506 to fill in any remaining data fields based on a machine learning model. A second user interface 510 depicts an example scenario after the user has selected the “smart default” button 506. As can be seen in the figure, the remaining data fields have been automatically filled in based on a machine learning model and the information previously entered by the user. For example, the machine learning model can be configured to receive transaction information entered by the user and to determine one or more similar transactions that have been previously entered. The remaining data fields can be automatically filled in based on the one or more similar transactions. For example, in the example scenario 500, the machine learning model can determine that this particular user (user ABC123) has previously entered several transactions defining the same “Instrument,” “Basis,” “Indexation,” and “Mutt. Margin” as those entered by the user in the current transaction. Based on those previous transactions, the machine learning model can automatically fill in the remaining data fields to approximate or match values that were used in the previous transactions.

In certain embodiments, the data input user interface 510 can also provide an indication of likelihood of error for any automatically inputted data fields. For example, automatically inputted data fields may be highlighted, and the shade of the highlighting can depend on a likelihood of error for the automatically inputted value, e.g., a darker shade of red highlighting could indicate a high likelihood of error and be indicative of a suggestion for manual user review. In other embodiments, only those automatically inputted data fields that do not satisfy a likelihood of error threshold (or certainty threshold) can be highlighted. For example, in the interface 510 of FIG. 5, a “Maturity Date” field is highlighted, indicating that that field was automatically filled in, but does not satisfy a certainty threshold. As such, the highlighting can indicate to a user that the user should manually review the highlighted field.

Returning once again to FIG. 3, the user interface module 308 can be configured to provide one or more graphical user interfaces for carrying out the various functionalities described above. For example, the user interface module 308 can provide a graphical user interface for a user that alerts the user to potential data input errors. In certain embodiments, as discussed above with respect to FIG. 4, transactions containing potentially erroneous data fields can be highlighted, or potentially erroneous data fields can be highlighted, or a widget can provide an indication that the user should double check certain data fields in a transaction. One or more buttons may be provided on a graphical user interface for a user to request detection of potential data input errors. A graphical user interface can also be provided for automated determination of one or more data fields. For example, as discussed above with respect to FIG. 5, a transaction information input interface can be provided for a user to input a subset of data fields for a transaction. A button or other selection can be provided for a user to request default values to be provided for any empty data fields.

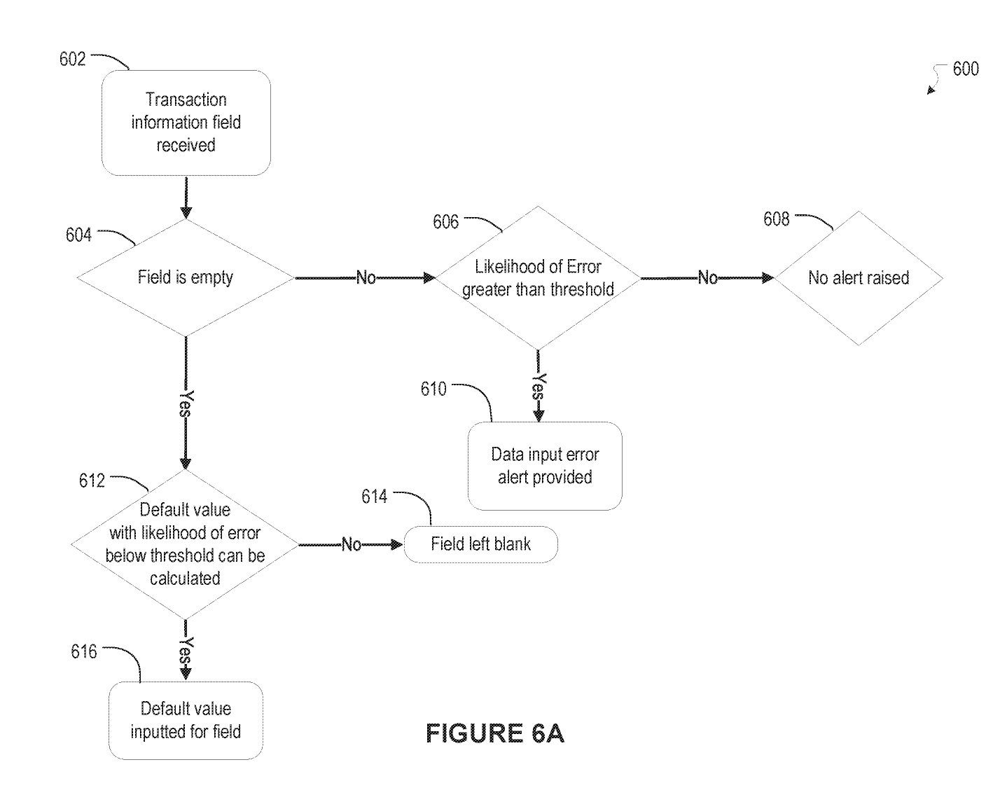

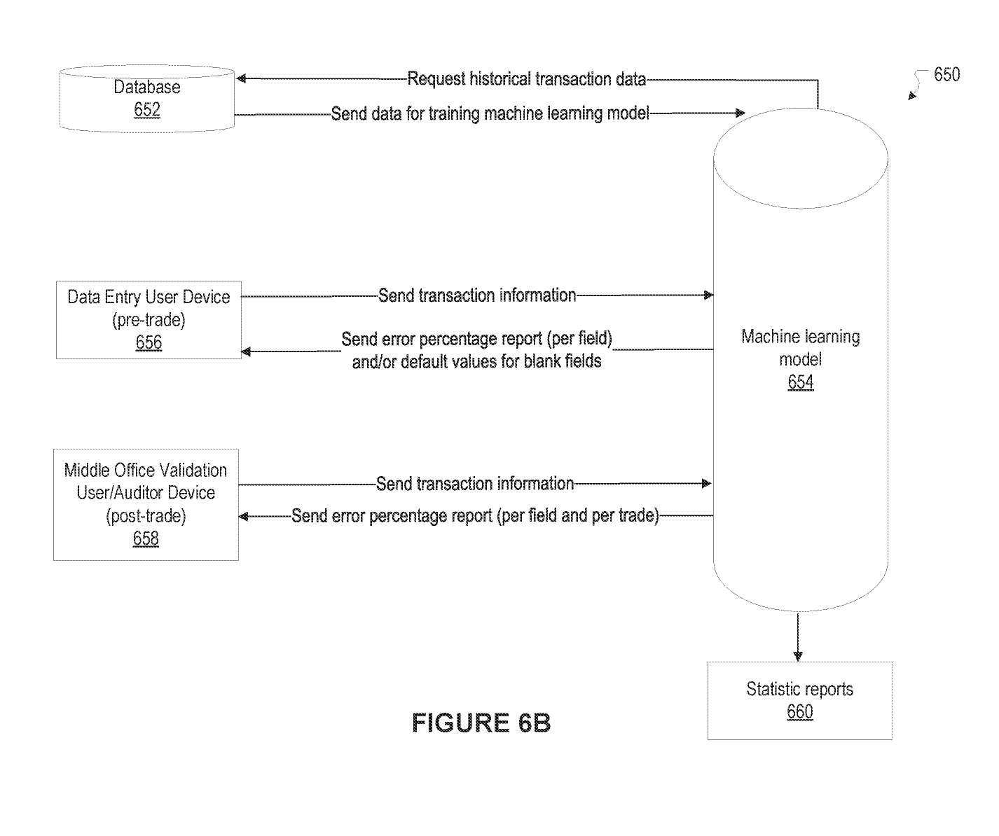

FIG. 6A illustrates a flow chart representative of an example method 600 associated with applying a machine learning model for automated data input error determination and default input determination. At block 602, transaction information is received, including a data field. At block 604, a determination is made as to whether or not the data field is empty. If the data field is not empty, the method 600 moves to block 606, in which a likelihood of error is determined for the data field based on a machine learning model. If the likelihood of error is not greater than a threshold, then no alert is raised (block 608). However, if the likelihood of error is greater than the threshold, then a data input error alert is provided to a user (block 610). Returning to block 604, if the data field is empty, then a determination is made at block 612 as to whether or not a default value having a likelihood of error below a threshold can be calculated. If a default value can be calculated, the default value is entered for the data field (block 616). If a default value cannot be calculated, then the data field is left blank (block 614). In certain embodiments, as discussed above, a default value can be calculated for all empty data fields. Rather than leaving a field blank if the likelihood of error is above the threshold, any automatically determined values that exceed the likelihood of error threshold can be indicated for a user so that the user can review the automatically inputted field (e.g., by highlighting the inputted value).

FIG. 6B illustrates a block diagram of an example system 650, in accordance with an embodiment of the present disclosure. The example system 650 includes a database 652 in communication with a machine learning model 654. The machine learning model 654 receives from the database 652 transaction data for a plurality of transactions to train the machine learning model. In certain embodiments, transaction data is provided periodically to the machine learning model 654 to continuously update the machine learning model 654's training. For example, every evening, a subset of transactions occurring the previous day can be provided to the machine learning model 654 for training.

A data entry user device 656 is also in communication with the machine learning model 654. Before a transaction is sent out for execution (e.g., as a data entry user is entering transaction data, once the data entry user has finished entering transaction data, and/or once the data entry user requests a data input check) transaction data can be sent to the machine learning model to conduct a check for potential data input errors. For each data field, a likelihood, or probability, of error is calculated based on the machine learning model, and the report is sent back for the user to see the result. For example, the result may be displayed as a highlighted data field to indicate a potential data input error, with the shade of the highlighting indicative of the likelihood of error. The machine learning model 654 can also provide default calculated values for any blank data fields for which a default value satisfying a threshold value of confidence (e.g., below a threshold potential error value) can be calculated.

A post-trade middle office validation user device 658 (or auditor device 658) is also in communication with the machine learning model 654. Once a data entry user has completed entering transaction data for one or more transactions, he can submit the transactions for processing and execution. Before the transaction data is exported to external entities for final processing and execution, the transaction data can be provided to a middle office, or auditor, for quality validation. As such, the auditor device 658 can also provide transaction information to the machine learning model 604 to receive assistance in detecting potential data input errors.

The machine learning model 654 can also be configured to output statistic reports 660. For example, at the end of each day, a report can be generated listing all errors that were detected and corrected during that day. These reports can be used to avoid future errors. For example, if a user is determined to be making a particular mistake with some frequency, the user can be notified of that issue so as to avoid making that same mistake in the future, or the user can be provided with additional training.

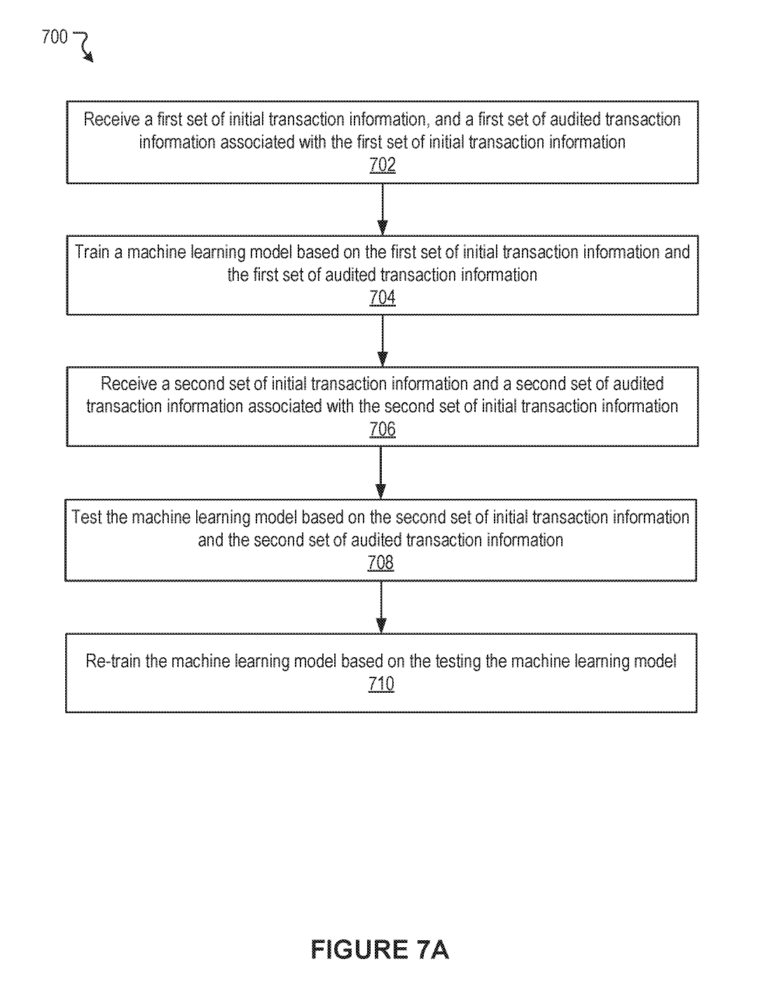

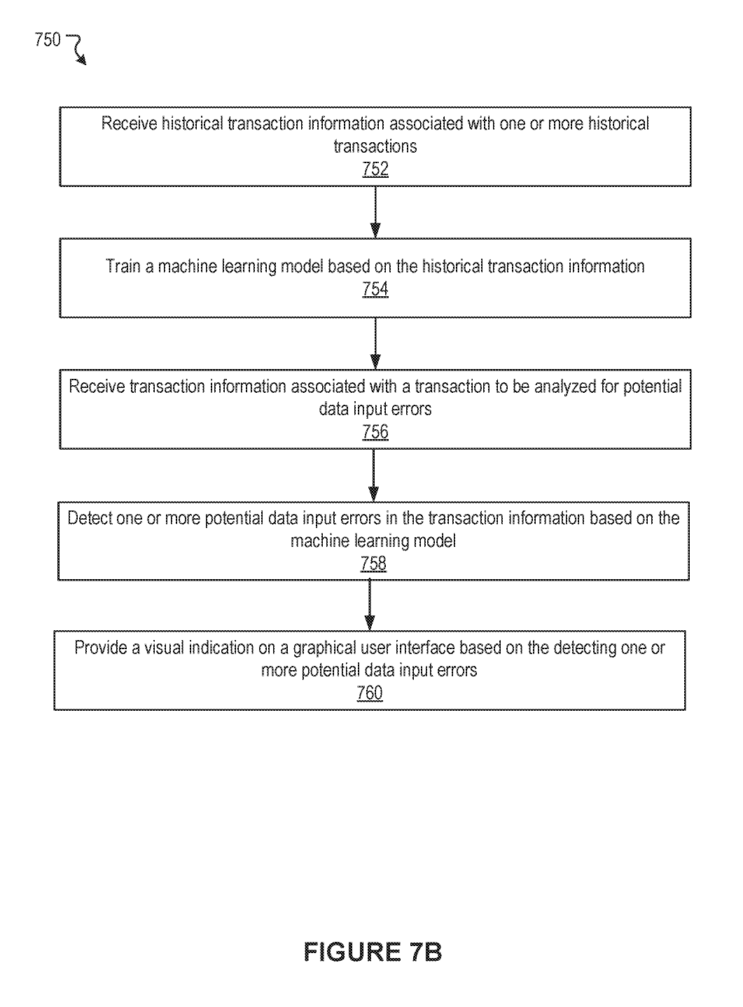

FIG. 7A illustrates an example method 700 associated with training and testing an automated data input error machine learning model, according to an embodiment of the present disclosure. It should be appreciated that there can be additional, fewer, or alternative steps performed in similar or alternative orders, or in parallel, within the scope of the various embodiments unless otherwise stated.

At block 702, the example method 700 can receive a first set of initial transaction information, and a first set of audited transaction information associated with the first set of initial transaction information. At block 704, the example method 700 can train a machine learning model based on the first set of initial transaction information and the first set of audited transaction information. At block 706, the example method 700 can receive a second set of initial transaction information and a second set of audited transaction information associated with the second set of initial transaction information. At block 708, the example method 700 can test the machine learning model based on the second set of initial transaction information and the second set of audited transaction information. At block 710, the example method 700 can re-train the machine learning model based on the testing the machine learning model.

FIG. 7B illustrates an example method 750 associated with automatically detecting data input errors based on a machine learning model, according to an embodiment of the present disclosure. It should be appreciated that there can be additional, fewer, or alternative steps performed in similar or alternative orders, or in parallel, within the scope of the various embodiments unless otherwise stated.

At block 752, the example method 750 can receive historical transaction information associated with one or more historical transactions. At block 754, the example method 750 can train a machine learning model based on the historical transaction information. At block 756, the example method 750 can receive transaction information associated with a transaction to be analyzed for potential data input errors. At block 758, the example method 750 can detect one or more potential data input errors in the transaction information based on the machine learning model. At block 760, the example method 750 can provide a visual indication on a graphical user interface based on the detecting one or more potential data input errors.

### Hardware Implementation

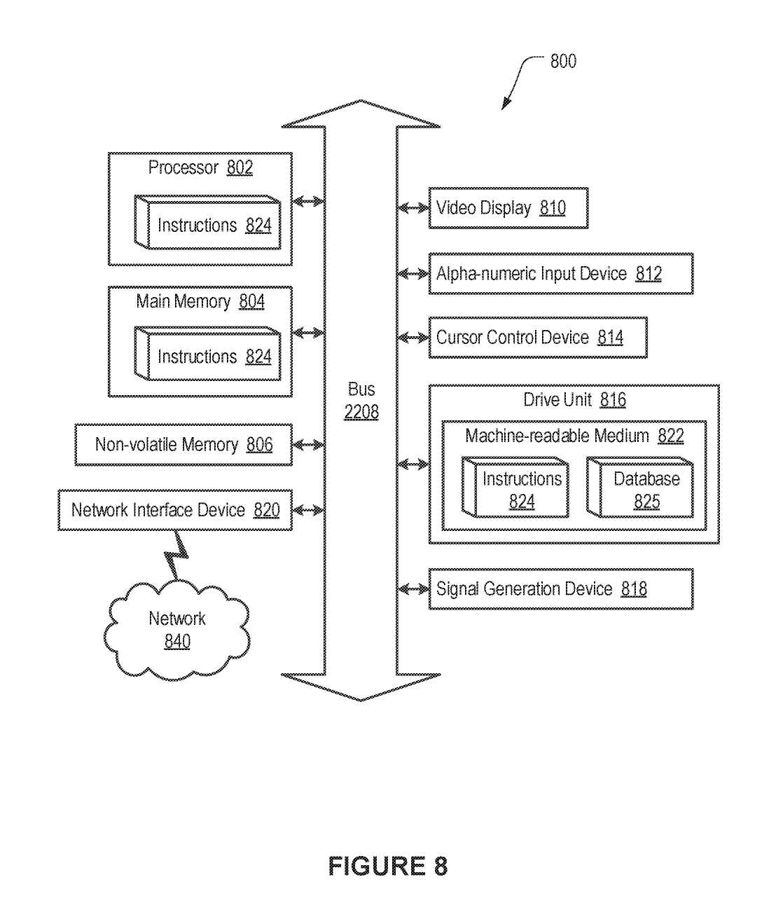

FIG. 8 is a diagrammatic representation of an embodiment of the machine 800, within which a set of instructions for causing the machine to perform one or more of the embodiments described herein can be executed. The machine may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The machine 800 includes a processor 802 (e.g., a central processing unit (CPU), a graphics processing unit (GPU), or both), a main memory 804, and a nonvolatile memory 806 (e.g., volatile RAM and non-volatile RAM), which communicate with each other via a bus 808. In some embodiments, the machine 800 can be a desktop computer, a laptop computer, personal digital assistant (PDA), or mobile phone, for example. In one embodiment, the machine 800 also includes a video display 810, an alphanumeric input device 812 (e.g., a keyboard), a cursor control device 814 (e.g., a mouse), a drive unit 816, a signal generation device 818 (e.g., a speaker) and a network interface device 820.

In one embodiment, the video display 810 includes a touch sensitive screen for user input. In one embodiment, the touch sensitive screen is used instead of a keyboard and mouse. The disk drive unit 816 includes a machine-readable medium 822 on which is stored one or more sets of instructions 824 (e.g., software) embodying any one or more of the methodologies or functions described herein. The instructions 824 can also reside, completely or at least partially, within the main memory 804 and/or within the processor 802 during execution thereof by the computer system 800. The instructions 824 can further be transmitted or received over a network 840 via the network interface device 820. In some embodiments, the machine-readable medium 822 also includes a database 825.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to any of the computer systems described herein through a network interface such as a modem or Ethernet interface, can also be used.

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals. The term “storage module” as used herein may be implemented using a machine-readable medium.

In general, routines executed to implement the embodiments of the invention can be implemented as part of an operating system or a specific application, component, program, object, module or sequence of instructions referred to as “programs” or “applications”. For example, one or more programs or applications can be used to execute any or all of the functionality, techniques, and processes described herein. The programs or applications typically comprise one or more instructions set at various times in various memory and storage devices in the machine and that, when read and executed by one or more processors, cause the machine to perform operations to execute elements involving the various aspects of the embodiments described herein.

The executable routines and data may be stored in various places, including, for example, ROM, volatile RAM, non-volatile memory, and/or cache. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of machines, those skilled in the art will appreciate that the various embodiments are capable of being distributed as a program product in a variety of forms, and that the embodiments described herein apply equally regardless of the particular type of machine- or computer-readable media used to actually effect the distribution. Examples of machine-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, or the like means that a particular feature, design, structure, or characteristic described in connection with the embodiment is included in at least one embodiment of the disclosure. The appearances of, for example, the phrases “according to an embodiment”, “in one embodiment”, “in an embodiment”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

What is claimed is:

1. A computer-implemented method comprising:
receiving, by a computing system, historical transaction information associated with one or more historical transactions;
training, by the computing system, a machine learning model based on the historical transaction information;
receiving, by the computing system, transaction information associated with a transaction to be analyzed for potential data input errors;
detecting, by the computing system, a potential data input error in the transaction information based on the machine learning model; and
providing, by the computing system, a visual indication on a graphical user interface based on the detecting the potential data input error.

2. The computer-implemented method of claim 1, wherein the detecting the potential data input error comprises:
determining a likelihood of error for a data field based on the machine learning model; and
determining that the likelihood of error exceeds a threshold likelihood value.

3. The computer-implemented method of claim 1, wherein the historical transaction information comprises
initial transaction information and
audited transaction information associated with the initial transaction information.

4. The computer-implemented method of claim 3, wherein the training the machine learning model based on the historical transaction information comprises:
determining historical errors based on differences between the initial transaction information and the audited transaction information.

5. The computer-implemented method of claim 3, wherein the training the machine learning model based on the historical transaction information further comprises:
receiving a second set of initial transaction information and a second set of audited transaction information associated with the second set of initial transaction information;
testing the machine learning model based on the second set of initial transaction information and the second set of audited transaction information; and
re-training the machine learning model based on the testing the machine learning model.

6. The computer-implemented method of claim 5, wherein,
the training the machine learning model comprises selecting a first machine learning algorithm, and
the re-training the machine learning model comprises selecting a second machine learning algorithm that is different from the first machine learning algorithm.

7. The computer-implemented method of claim 1, wherein the visual indication on the graphical user interface comprises highlighting the potential data input error.

8. The computer-implemented method of claim 7, wherein the shade of the highlighting varies based on a likelihood of error determination made by the machine learning model.

9. The computer-implemented method of claim 1, wherein
the transaction information comprises a blank data field, and
the method further comprises
calculating a default value for the blank data field based on the machine learning model.

10. The computer-implemented method of claim 9, wherein the default value comprises a value satisfying a threshold likelihood of error as determined by the machine learning model.

11. A system comprising:
at least one processor; and
a memory storing instructions that, when executed by the at least one processor, cause the system to perform:
receiving historical transaction information associated with one or more historical transactions;
training a machine learning model based on the historical transaction information;
receiving transaction information associated with a transaction to be analyzed for potential data input errors;
detecting a potential data input error in the transaction information based on the machine learning model; and
providing a visual indication on a graphical user interface based on the detecting the potential data input error.

12. The system of claim 11, wherein the detecting the potential data input error comprises:
determining a likelihood of error for a data field based on the machine learning model; and
determining that the likelihood of error exceeds a threshold likelihood value.

13. The system of claim 11, wherein the historical transaction information comprises
initial transaction information and
audited transaction information associated with the initial transaction information.

14. The system of claim 13, wherein the training the machine learning model based on the historical transaction information comprises:
determining historical errors based on differences between the initial transaction information and the audited transaction information.

15. The system of claim 13, wherein the training the machine learning model based on the historical transaction information further comprises:
receiving a second set of initial transaction information and a second set of audited transaction information associated with the second set of initial transaction information;
testing the machine learning model based on the second set of initial transaction information and the second set of audited transaction information; and
re-training the machine learning model based on the testing the machine learning model.

16. A non-transitory computer-readable storage medium including instructions that, when executed by at least one processor of a computing system, cause the computing system to perform:
receiving historical transaction information associated with one or more historical transactions;
training a machine learning model based on the historical transaction information;
receiving transaction information associated with a transaction to be analyzed for potential data input errors;
detecting a potential data input error in the transaction information based on the machine learning model; and
providing a visual indication on a graphical user interface based on the detecting the potential data input error.

17. The non-transitory computer-readable storage medium of claim 16, wherein the detecting the potential data input error comprises:
determining a likelihood of error for a data field based on the machine learning model; and
determining that the likelihood of error exceeds a threshold likelihood value.

18. The non-transitory computer-readable storage medium of claim 16, wherein the historical transaction information comprises
initial transaction information and
audited transaction information associated with the initial transaction information.

19. The non-transitory computer-readable storage medium of claim 18, wherein the training the machine learning model based on the historical transaction information comprises:
determining historical errors based on differences between the initial transaction information and the audited transaction information.

20. The non-transitory computer-readable storage medium of claim 18, wherein the training the machine learning model based on the historical transaction information further comprises:
receiving a second set of initial transaction information and a second set of audited transaction information associated with the second set of initial transaction information;
testing the machine learning model based on the second set of initial transaction information and the second set of audited transaction information; and
re-training the machine learning model based on the testing the machine learning model.
